(19) United States
(12) Patent Application Publication
(10) Pub. No.: US 2013/0332540 A1
(43) Pub. Date: Dec. 12, 2013

(54) Structural Presentation and Smart Alerts for Instant Messaging Contacts

(71) Applicant: Amita Asit Vadhavkar, Pune (IN)

(72) Inventor: Amita Asit Vadhavkar, Pune (IN)

(73) Assignee: INTERNATIONAL BUSINESS MACHINES CORPORATION, Armonk, NY (US)

(21) Appl. No.: 13/494,905

(22) Filed: Jun. 12, 2012

(51) Int. Cl. G06F 15/16

(52) U.S. Cl. 709/206

(57) ABSTRACT

An approach is provided that receives an instant message request from a user. The instant message request includes attributes. Instant messaging contacts are retrieved from one or more instant messaging repositories. The retrieved instant messaging contacts are retrieved because of one or more attributes requested by the user. Instant messaging presentation rules are retrieved with the rules being configurable by the user. A presentation type is then selected based on the retrieved rules. The instant messaging contacts are displayed in a display format corresponding to the selected presentation type. User selections are received that correspond to one or more of the instant messaging contacts being displayed. An instant message is then sent from the user to the instant message contacts selected by the user.

### TECHNICAL FIELD

The present disclosure relates to instant messaging (IM). More particularly, the present disclosure relates to an approach that provides structured IM contact presentations and the triggering of smart alerts.

### BACKGROUND OF THE INVENTION

Instant messaging (IM) is a form of communication over a computer network, such as the Internet. IM offers a near-instantaneous transmission of text-based messages from sender to receiver. The sender's text is conveyed over a network, such as the Internet. The IM message may be addressed using point-to-point communications as well as using multicast communications that allows communication from one sender to many receivers. More advanced instant messaging allows enhanced modes of communication and inclusion of hyperlinks to network-accessible media. Instant messaging is typically used to communicate more effectively where immediate information broadcast or immediate communication is required as opposed to emails which have an asynchronous response. In addition, instant messaging is not as intrusive nor does it interrupt recipients as much as using a traditional telephone to contact recipients. The contacts in the instant messenger application are generally stored in one or more identity repositories. In traditional systems, IM recipients are selected mostly based on email searches, name searches, or based on other attributes. The IM recipients are typically grouped based on the sender's identification of different groups.

### SUMMARY

According to one embodiment of the present invention, an approach is provided that receives an instant message request from a user. The instant message request includes attributes. Instant messaging contacts are retrieved from one or more instant messaging repositories. The retrieved instant messaging contacts are retrieved because of one or more attributes requested by the user. Instant messaging presentation rules are retrieved with the rules being configurable by the user. A presentation type is then selected based on the retrieved rules. The instant messaging contacts are displayed in a display format corresponding to the selected presentation type. User selections are received that correspond to one or more of the instant messaging contacts being displayed. An instant message is then sent from the user to the instant message contacts selected by the user.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings, wherein:

FIG. 1 is a block diagram of a data processing system in which the methods described herein can be implemented;

FIG. 2 provides an extension of the information handling system environment shown in FIG. 1 to illustrate that the methods described herein can be performed on a wide variety of information handling systems which operate in a networked environment;

FIG. 3 is a block diagram depicting components utilized for providing structural presentation and smart alerts for instant messaging contacts;

FIG. 4 is a high level flowchart depicting steps taken to provide structural presentation and smart alerts;

FIG. 5 is a flowchart depicting more detailed steps taken in providing a structured instant message presentation to a user;

FIG. 6 is a flowchart depicting steps taken used to process user selections from the structured instant message presentation;

FIG. 7 is a flowchart depicting steps taken to update rules used to process instant message contact data in order to provide instant messaging presentation forms useful to the user;

FIG. 8 is a flowchart showing steps taken to update instant message contact information and messaging metadata; and

FIG. 9 is a flowchart showing steps taken to perform data mining on messages stored in a message repository to add instant message contact groups and update contact relationships.

### DETAILED DESCRIPTION

Certain specific details are set forth in the following description and figures to provide a thorough understanding of various embodiments of the invention. Certain well-known details often associated with computing and software technology are not set forth in the following disclosure, however, to avoid unnecessarily obscuring the various embodiments of the invention. Further, those of ordinary skill in the relevant art will understand that they can practice other embodiments of the invention without one or more of the details described below. Finally, while various methods are described with reference to steps and sequences in the following disclosure, the description as such is for providing a clear implementation of embodiments of the invention, and the steps and sequences of steps should not be taken as required to practice this invention. Instead, the following is intended to provide a detailed description of an example of the invention and should not be taken to be limiting of the invention itself. Rather, any number of variations may fall within the scope of the invention, which is defined by the claims that follow the description.

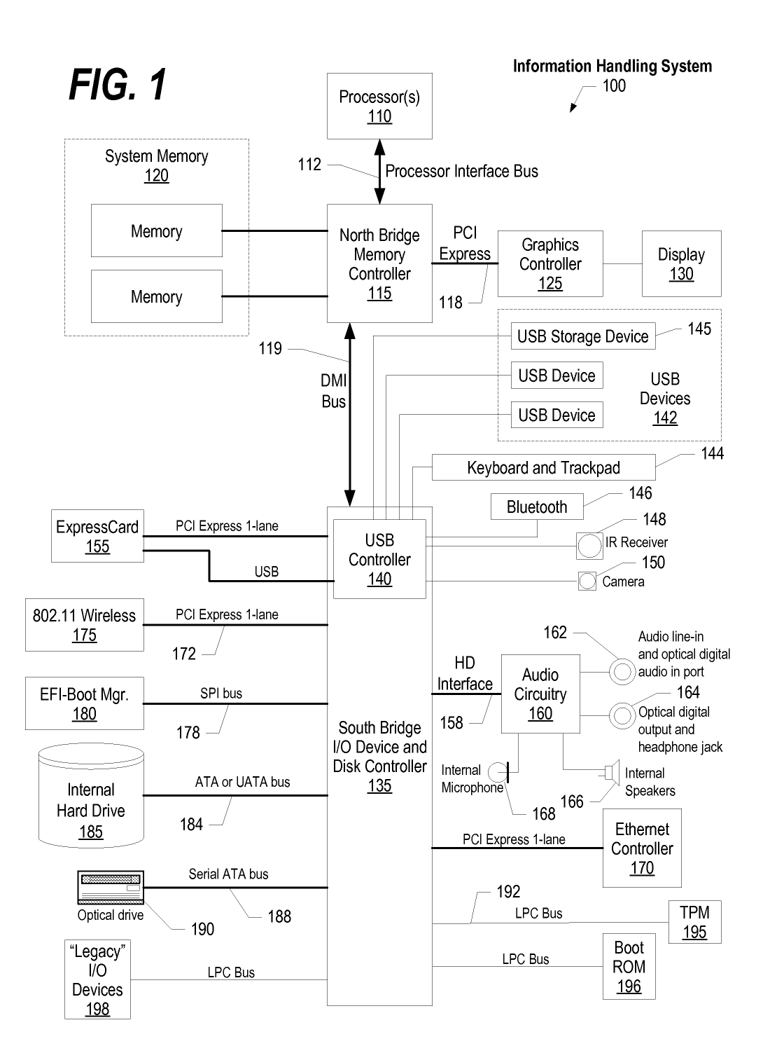

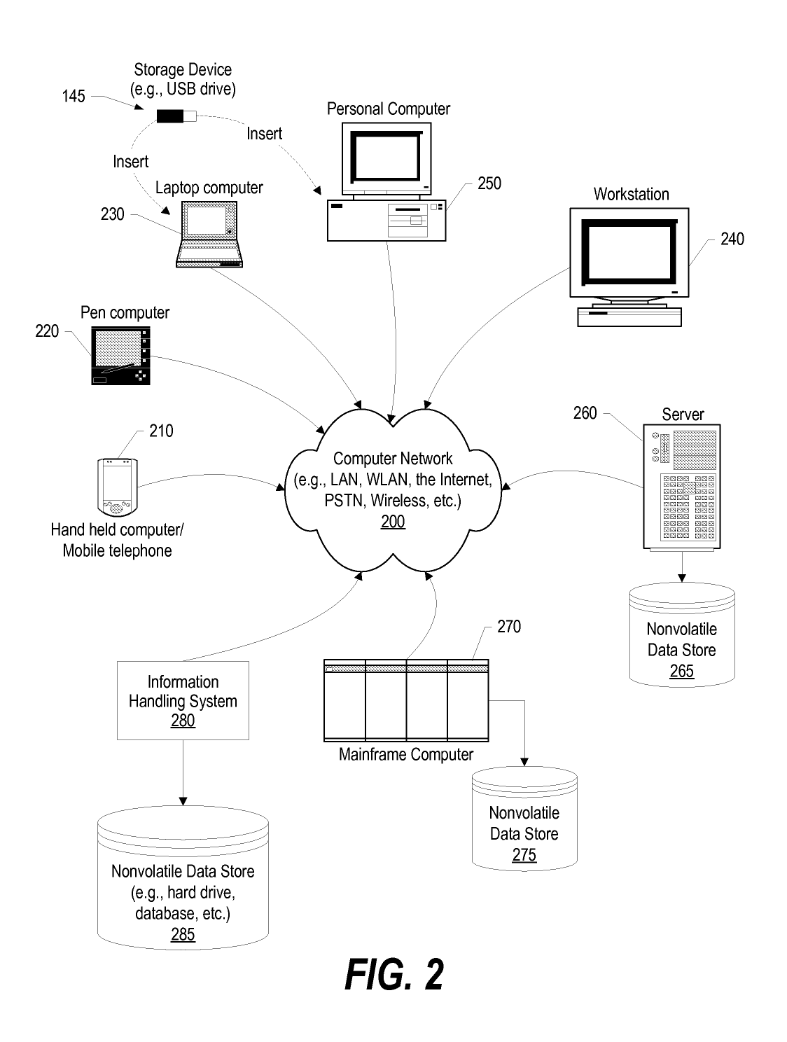

The following detailed description will generally follow the summary of the invention, as set forth above, further explaining and expanding the definitions of the various aspects and embodiments of the invention as necessary. To this end, this detailed description first sets forth a computing environment in FIG. 1 that is suitable to implement the software and/or hardware techniques associated with the invention. A networked environment is illustrated in FIG. 2 as an extension of the basic computing environment, to emphasize that modern computing techniques can be performed across multiple discrete devices.

FIG. 1 illustrates information handling system 100, which is a simplified example of a computer system capable of performing the computing operations described herein. Information handling system 100 includes one or more processors 110 coupled to processor interface bus 112. Processor interface bus 112 connects processors 110 to Northbridge 115, which is also known as the Memory Controller Hub (MCH). Northbridge 115 connects to system memory 120 and provides a means for processor(s) 110 to access the system memory. Graphics controller 125 also connects to Northbridge 115. In one embodiment, PCI Express bus 118 connects Northbridge 115 to graphics controller 125. Graphics controller 125 connects to display device 130, such as a computer monitor.

Northbridge 115 and Southbridge 135 connect to each other using bus 119. In one embodiment, the bus is a Direct Media Interface (DMI) bus that transfers data at high speeds in each direction between Northbridge 115 and Southbridge 135. In another embodiment, a Peripheral Component Interconnect (PCI) bus connects the Northbridge and the Southbridge. Southbridge 135, also known as the I/O Controller Hub (ICH) is a chip that generally implements capabilities that operate at slower speeds than the capabilities provided by the Northbridge. Southbridge 135 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 196 and “legacy” I/O devices (using a “super I/O” chip). The “legacy” I/O devices (198) can include, for example, serial and parallel ports, keyboard, mouse, and/or a floppy disk controller. The LPC bus also connects Southbridge 135 to Trusted Platform Module (TPM) 195. Other components often included in Southbridge 135 include a Direct Memory Access (DMA) controller, a Programmable Interrupt Controller (PIC), and a storage device controller, which connects Southbridge 135 to nonvolatile storage device 185, such as a hard disk drive, using bus 184.

ExpressCard 155 is a slot that connects hot-pluggable devices to the information handling system. ExpressCard 155 supports both PCI Express and USB connectivity as it connects to Southbridge 135 using both the Universal Serial Bus (USB) the PCI Express bus. Southbridge 135 includes USB Controller 140 that provides USB connectivity to devices that connect to the USB. These devices include webcam (camera) 150, infrared (IR) receiver 148, keyboard and trackpad 144, and Bluetooth device 146, which provides for wireless personal area networks (PANs). USB Controller 140 also provides USB connectivity to other miscellaneous USB connected devices 142, such as a mouse, removable nonvolatile storage device 145, modems, network cards, ISDN connectors, fax, printers, USB hubs, and many other types of USB connected devices. While removable nonvolatile storage device 145 is shown as a USB-connected device, removable nonvolatile storage device 145 could be connected using a different interface, such as a Firewire interface, etcetera.

Wireless Local Area Network (LAN) device 175 connects to Southbridge 135 via the PCI or PCI Express bus 172. LAN device 175 typically implements one of the IEEE .802.11 standards of over-the-air modulation techniques that all use the same protocol to wireless communicate between information handling system 100 and another computer system or device. Optical storage device 190 connects to Southbridge 135 using Serial ATA (SATA) bus 188. Serial ATA adapters and devices communicate over a high-speed serial link. The Serial ATA bus also connects Southbridge 135 to other forms of storage devices, such as hard disk drives. Audio circuitry 160, such as a sound card, connects to Southbridge 135 via bus 158. Audio circuitry 160 also provides functionality such as audio line-in and optical digital audio in port 162, optical digital output and headphone jack 164, internal speakers 166, and internal microphone 168. Ethernet controller 170 connects to Southbridge 135 using a bus, such as the PCI or PCI Express bus. Ethernet controller 170 connects information handling system 100 to a computer network, such as a Local Area Network (LAN), the Internet, and other public and private computer networks.

While FIG. 1 shows one information handling system, an information handling system may take many forms. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

The Trusted Platform Module (TPM 195) shown in FIG. 1 and described herein to provide security functions is but one example of a hardware security module (HSM). Therefore, the TPM described and claimed herein includes any type of HSM including, but not limited to, hardware security devices that conform to the Trusted Computing Groups (TCG) standard, and entitled “Trusted Platform Module (TPM) Specification Version 1.2.” The TPM is a hardware security subsystem that may be incorporated into any number of information handling systems, such as those outlined in FIG. 2.

FIG. 2 provides an extension of the information handling system environment shown in FIG. 1 to illustrate that the methods described herein can be performed on a wide variety of information handling systems that operate in a networked environment. Types of information handling systems range from small handheld devices, such as handheld computer/mobile telephone 210 to large mainframe systems, such as mainframe computer 270. Examples of handheld computer 210 include personal digital assistants (PDAs), personal entertainment devices, such as MP3 players, portable televisions, and compact disc players. Other examples of information handling systems include pen, or tablet, computer 220, laptop, or notebook, computer 230, workstation 240, personal computer system 250, and server 260. Other types of information handling systems that are not individually shown in FIG. 2 are represented by information handling system 280. As shown, the various information handling systems can be networked together using computer network 200. Types of computer network that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems shown in FIG. 2 depicts separate nonvolatile data stores (server 260 utilizes nonvolatile data store 265, mainframe computer 270 utilizes nonvolatile data store 275, and information handling system 280 utilizes nonvolatile data store 285). The nonvolatile data store can be a component that is external to the various information handling systems or can be internal to one of the information handling systems. In addition, removable nonvolatile storage device 145 can be shared among two or more information handling systems using various techniques, such as connecting the removable nonvolatile storage device 145 to a USB port or other connector of the information handling systems.

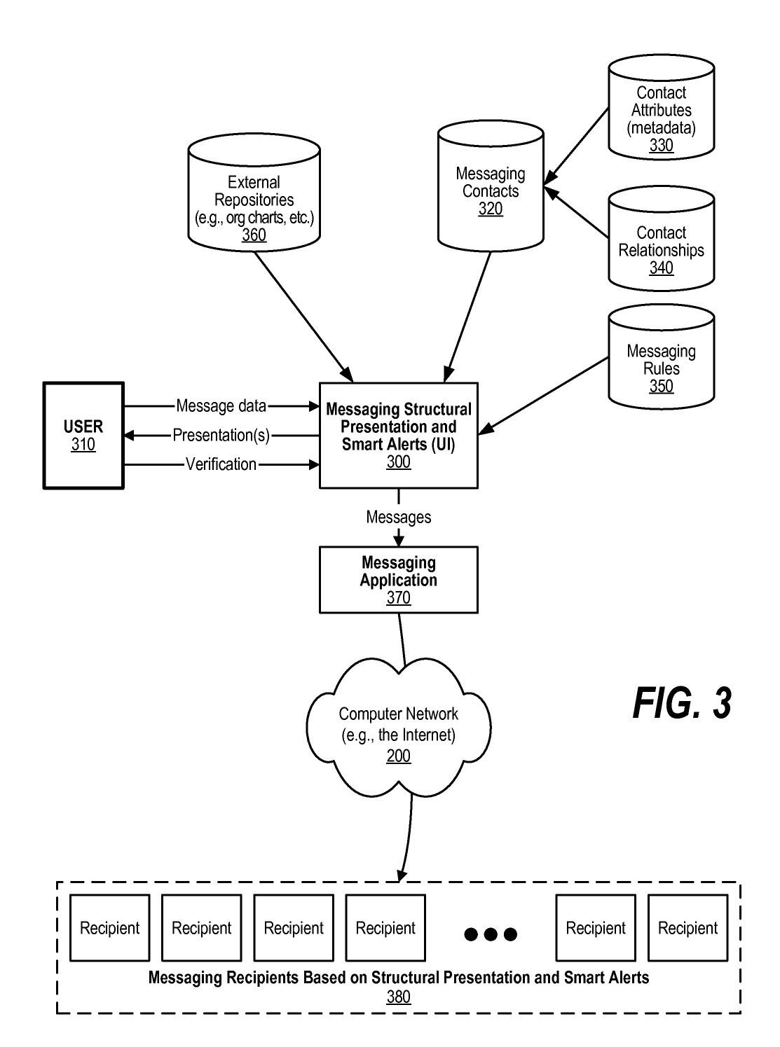

FIG. 3 is a block diagram depicting components utilized for providing structural presentation and smart alerts for instant messaging contacts. Process 300 provides functionality for providing messaging structural presentations and smart alerts through the user of a user interface (UI). As shown, user 310 interacts with process 300 by providing message data that include message requests and requested attributes regarding the message requests. In addition, user 310 provides instant messaging presentation rules that are, in one embodiment, tailored to the user's use of the system. In this manner, user 310 can configure process 300 based on the user's needs. User 310 also responds to notifications and alerts delivered by the system to the user. Through the process, the user may also provide additional detail regarding the user's contacts and the various relationships that the user has with the user's contacts.

System 300 retrieves contact related data from various instant messaging data repositories. These instant messaging repositories include instant messaging contacts data store 320, instant messaging presentation rules data store 350, and external repositories data stores 360. External repositories are not necessarily instant messaging data stores but can include supplemental information, such as organizational charts and other relationship information, maintained outside of the instant messaging system. Instant messaging contacts data store 320 is related to contact attributes data store 330 which include metadata regarding the instant messaging contacts. Instant messaging contacts data store 320 is also related to instant messaging contact relationships data store 340 which define instant messaging groups to which the various instant messaging contacts belong.

System 300 processes the user's instant messaging request that includes one or more attributes being requested by the user. Examples of attributes that can be requested by the user include a contact name, an organization name, a subject description or name, or any other information that process 300 can use to pull instant messaging contacts from the various data stores. In other words, process 300 retrieves various instant messaging contacts from the instant messaging repositories based on the attributes requested by the user. In addition, process 300 selects one or more instant messaging presentation rules from instant messaging rules repository 350. As previously mentioned, these instant messaging presentation rules can be previously configured by the user to tailor the system to the user's needs. A presentation type is selected by process 300 based on the instant messaging presentation rules that were retrieved. Presentation types include topographical presentation types as well as traditional list presentation types. Examples of topographical presentation types include star views, tree views, chain views, and loop views. For example, organizational structures can be displayed using star views and tree views with the star view shows a particular contact and relationships from the contact arranged in a star formation, whereas the tree view shows a particular contact and relationships above and below the contact arranged in a traditional tree view (e.g., commonly used to show directory/folder contents in a file system, etc.). The loop view is used, for example, to show relationships between contacts in a functional environment (e.g., a warehouse contact, related to a purchasing contact, the purchasing contact related to a billing contact, the billing contact who is related to a material management contact, and the material management contact related to the warehouse contact). The chain view shows relationships between contacts, not typically related in a hierarchical fashion, but chained to one another like the loop view but not completing a complete circuit. If the retrieved instant message presentation rules do not indicate use of a topographical presentation, then a traditional list view may be presented to the user (e.g., a list of people in a department or on a sports team, etc.). In addition, process 300 provides alerts to user 310 informing the user when additional contacts might be added to the groups (e.g., a new member in an organization, etc.) or when a stale contact is identified (e.g., an existing member of a group leaves the organization or obtains a different role as reflected in external repository data, etc.).

User 310 verifies the contact selection of contacts presented by process 300 as well as verifies new contacts that are added to an instant messaging group and stale contacts that are removed from an instant messaging group. System 300 interacts with user 310 to generate group oriented instant messages that are transmitted by instant messaging application 370 to recipients 380 via computer network 200. Note that the instant messaging recipients are based upon the structural presentation of the user's instant messaging contacts as well as the inclusion, and exclusion, of instant messaging contacts based upon smart alerts provided by system 300.

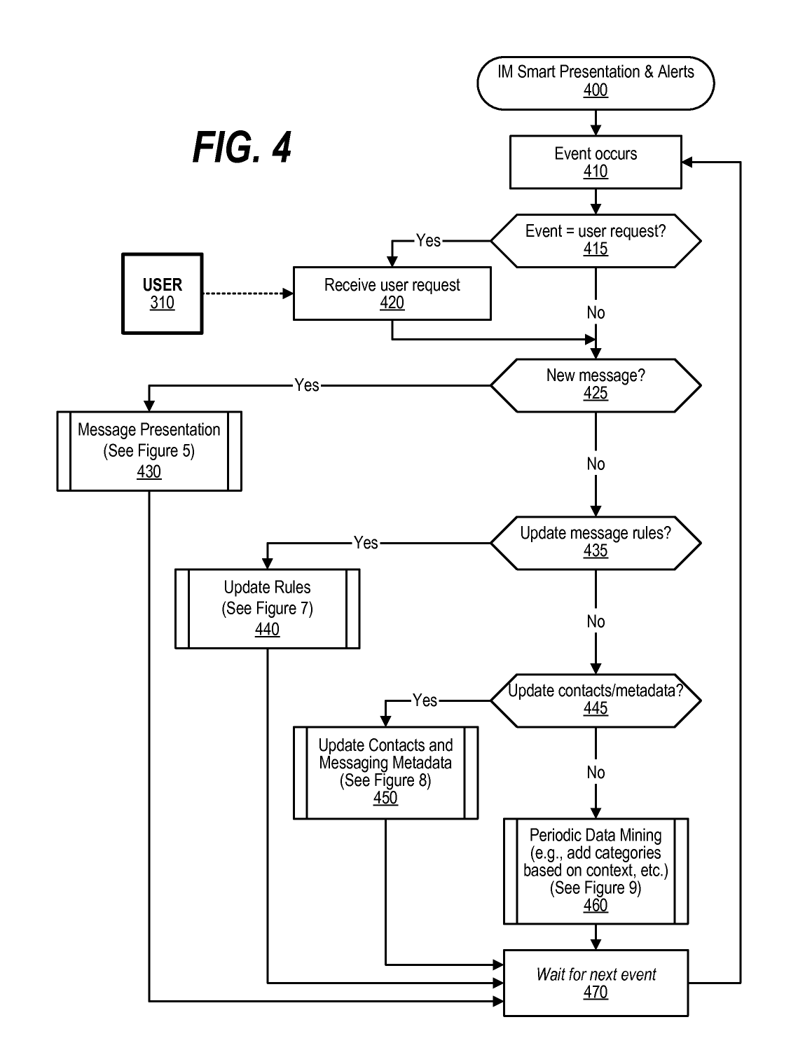

FIG. 4 is a high level flowchart depicting steps taken to provide structural presentation and smart alerts. Processing commences at 400 whereupon, at step 410, an event occurs such as the reception of a user event, a periodically occurring event (e.g., data mining), or the like. A decision is made as to whether the event is a user request (decision 415). If the event is a user request, then decision 415 branches to the “yes” branch whereupon, at step 420, the process receives the user request from user 310. Processing then continues to process the received user request.

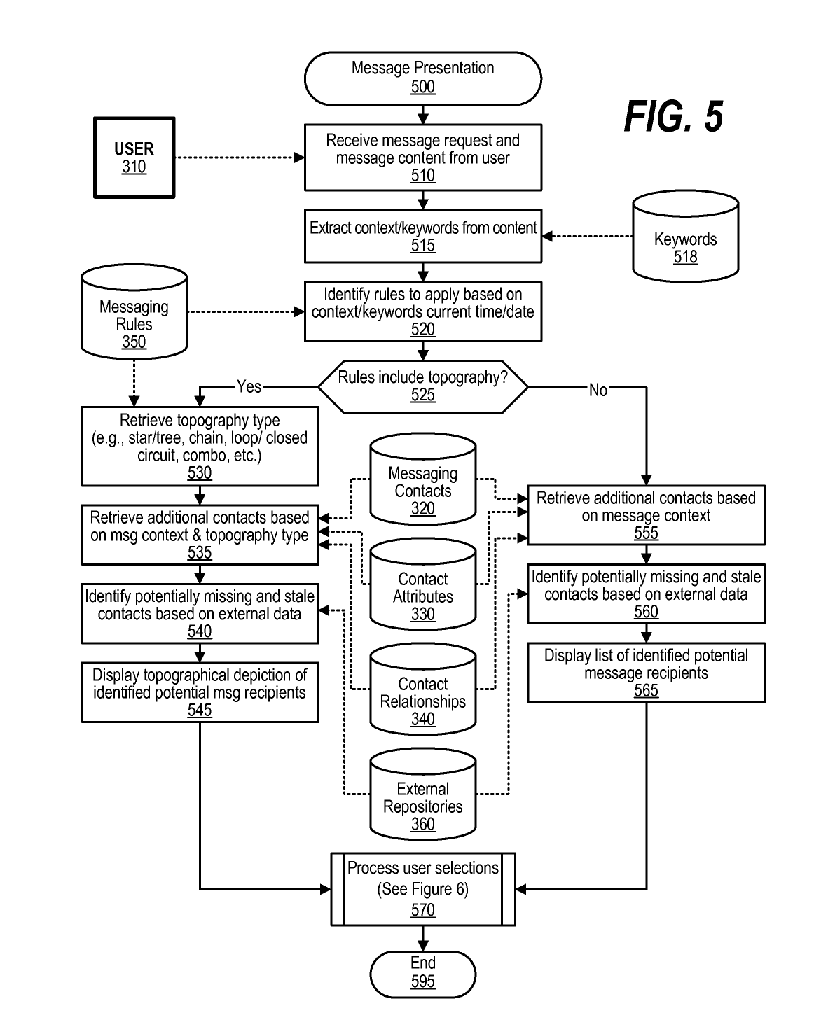

A decision is made as to whether the event (e.g., user request, etc.) is a request to generate a new instant message (decision 425). If the instant message request is a user request to create a new instant message, then decision 425 branches to the “yes” branch whereupon, at predefined process 430, the message presentation process is performed (see FIG. 5 and corresponding text for processing details). On the other hand, if the request is not a new message request, then decision 425 branches to the “no” branch to continue processing the event (which may be a user request).

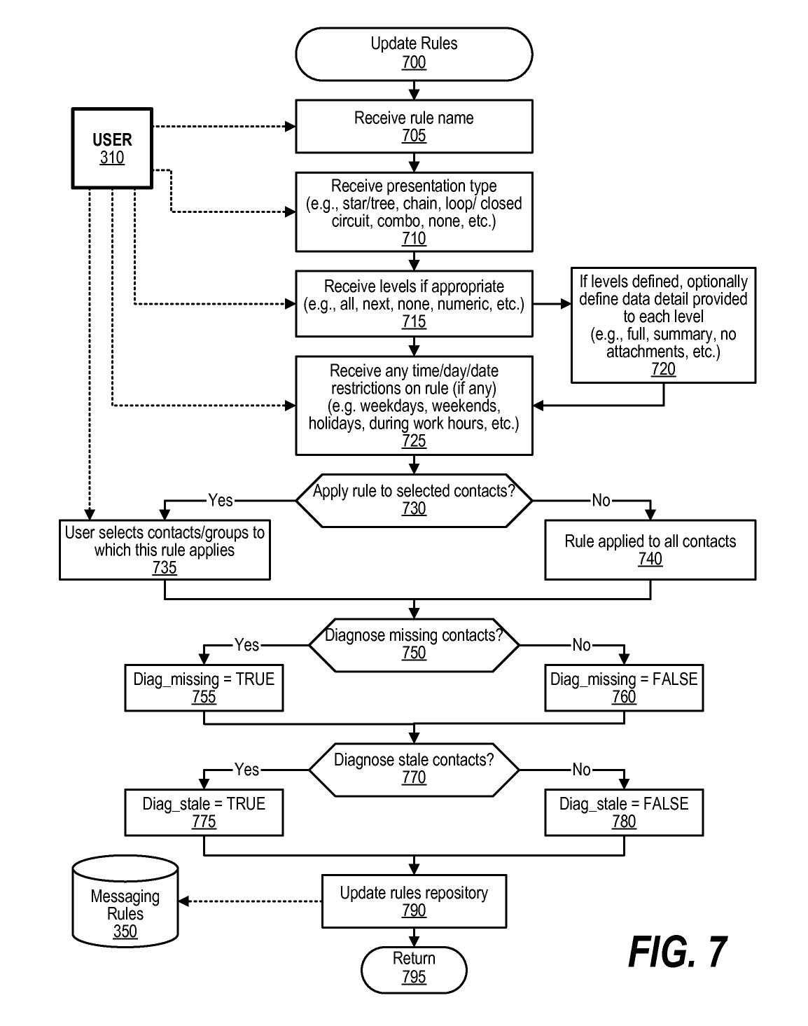

A decision is made as to whether the event is a user request to update the instant messaging presentation rules used by message presentation predefined process 430 (decision 435). If the request is a request to update instant messaging presentation rules, then decision 435 branches to the “yes” branch whereupon, at predefined process 440, the instant messaging presentation rules are updated (see FIG. 7 and corresponding text for processing details). On the other hand, if the request is not a request to update instant messaging presentation rules, then decision 435 branches to the “no” branch to continue processing the event (which may be a user request).

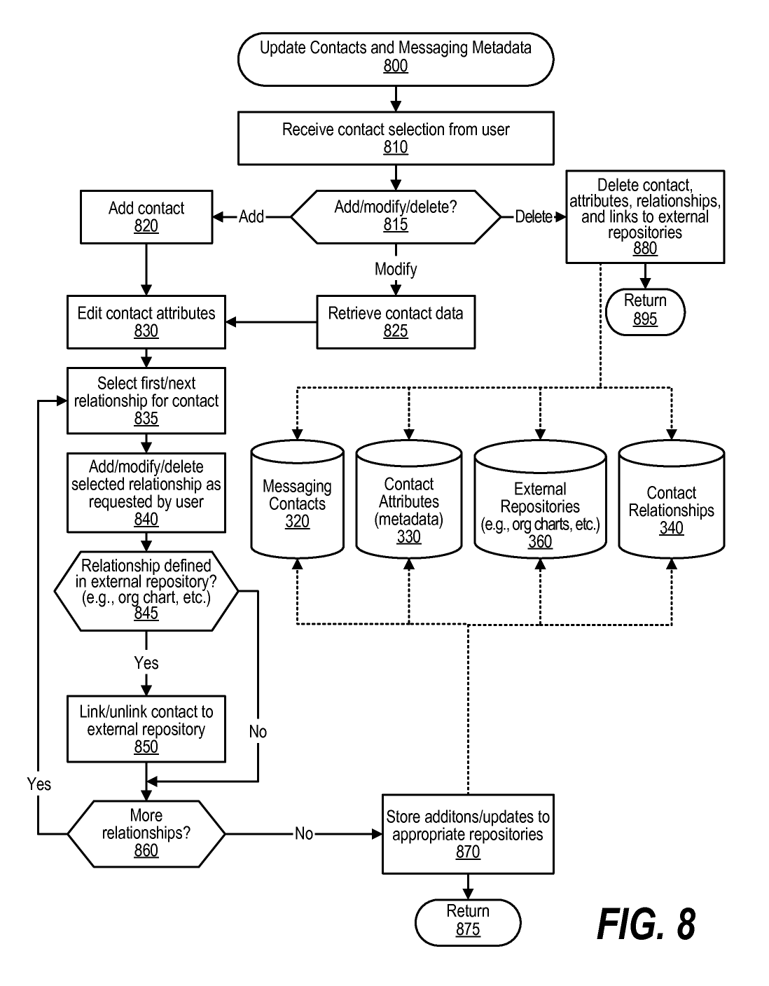

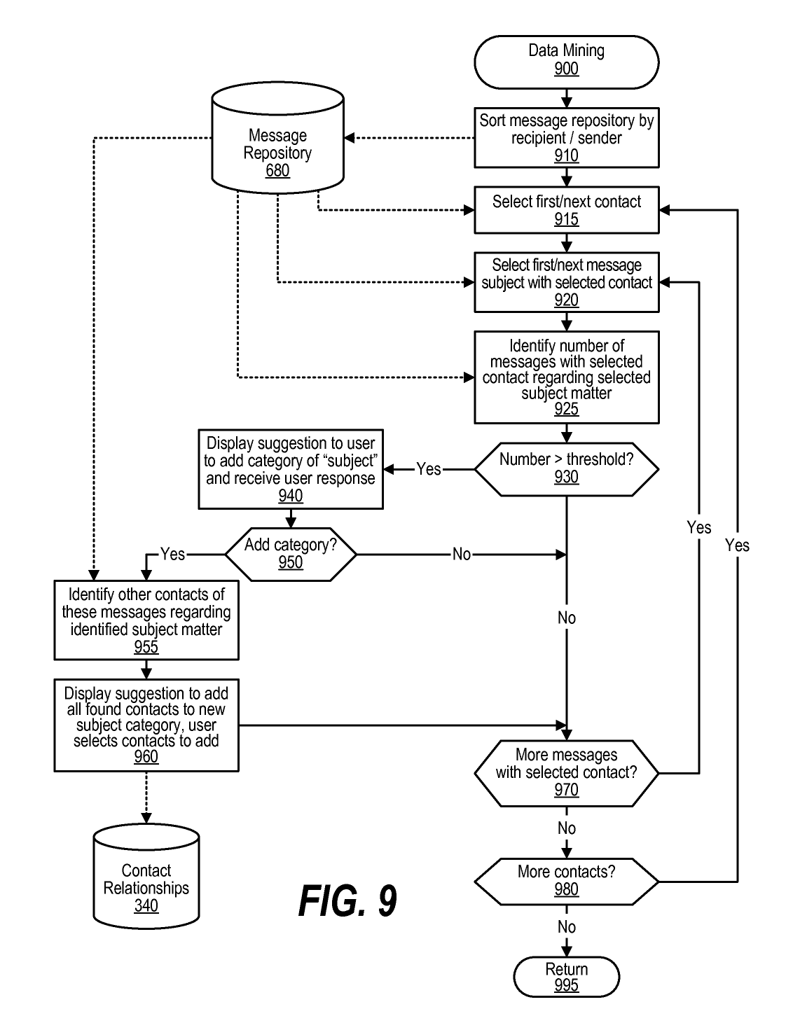

A decision is made as to whether the event is a user request to update the user's instant messaging contacts and metadata (attributes) regarding the contacts (decision 445). If the request is a request to update the user's instant messaging contacts and metadata (attributes) regarding the contacts, then decision 445 branches to the “yes” branch whereupon, at predefined process 450, the user's instant messaging contacts and metadata (attributes) regarding the contacts are updated (see FIG. 8 and corresponding text for processing details). On the other hand, if the request is not a request to update the user's instant messaging contacts and metadata (attributes) regarding the contacts, then decision 445 branches to the “no” branch whereupon, since no other conditions were met, the event is a periodic data mining event used to add contacts, relationships, groups, etc. based on the context of previously sent and received instant messages (see FIG. 9 and corresponding text for processing details).

After the event (which may have been a user request) has been processed, then, at step 470, the process waits for the next event to occur. When the next event occurs, processing loops back to step 410 to process the event as described above.

FIG. 5 is a flowchart depicting more detailed steps taken in providing a structured instant message presentation to a user. Processing commences at 500 whereupon, at step 510, the message request and message content is received from user 310 via an input device (e.g., keyboard, keypad, voice control, etc.). At step 515, contextual words as well as keywords are extracted from the message content. In one embodiment, the words in the message content are compared with predefined keywords 518. Keywords can be modified based on the user's preferences.

At step 520, the instant messaging presentation rules that apply to the message are retrieved from data store 350 with the retrieved instant messaging presentation rules being based on the context and/or keywords extracted from the message. A decision is made as to whether the retrieved instant messaging presentation rules include a presentation topography (decision 525). As previously described in the description of FIG. 4, instant messaging presentation rule topographies include topographies such as a star topography, a tree topography, a chain topography, a loop (closed circuit) topography, or a combination topography that utilizes more than one topography.

If the retrieved instant messaging presentation rules include a topography, then decision 525 branches to the “yes” branch whereupon, at step 530, the topography type is retrieved from the retrieved instant messaging presentation rule. At step 535, additional instant messaging contacts are retrieved from instant messaging contacts data store 320 based on the contacts' attributes. For example, in a star or tree topography step 530 might retrieve contacts at various levels in an organization's reporting structure. As shown, the attributes that apply to the various contacts are retrieved from instant messaging contacts attributes data store 330 and the relationships between the various contacts (e.g., levels in the reporting chain, members of a department, etc.) are retrieved from instant messaging contact relationships data store 340. At step 540, the process identifies potentially missing and stale contacts from external data stores 360. For example, an organization's org chart might be found in an external repository and this data store may indicate that a new member has been added to the reporting structure (a potentially missing contact) as well as identifying that a previous contact in the reporting structure is no longer in the reporting structure (a stale contact). These potentially stale and missing contacts can be displayed to the user in order for the user to update their contacts data and in order to send the instant message to the proper contacts based on the content (context and keywords) of the message. At step 545, a topographical presentation, or depiction, is displayed to the user with the displayed presentation type being the topography type that was retrieved in step 530.

On the other hand, if the retrieved instant messaging presentation rule (or rules) do not include a topography, then decision 525 branches to the “no” branch whereupon, at step 550, any additional contacts are retrieved based upon the context and keywords of the message matching with the attributes associated with the additional contacts. For example, if the context of the instant message concerns a particular project, then the additional contacts that are retrieved might have attributes indicating that the additional contacts are working on the project. At step 560, the process identifies potentially missing and stale contacts from external data stores 360. For example, a project listing might be found in an external repository that indicates that a new contact is now working on the project (a missing contact) as well as identifying that another contact currently in the project group is no longer working on the project (a stale contact). These potentially stale and missing contacts can be displayed to the user in order for the user to update their contacts data and in order to send the instant message to the proper contacts based on the content (context and keywords) of the message. At step 565, a non-topographical presentation, such as a simple list, is displayed to the user showing the various contacts.

Regardless of the presentation style (topographical or non-topographical) used as determined by the instant messaging presentation rules, the user's selections are processed using the steps shown in predefined process 570. After predefined process 570 has been performed, message presentation processing thereafter ends at 595.

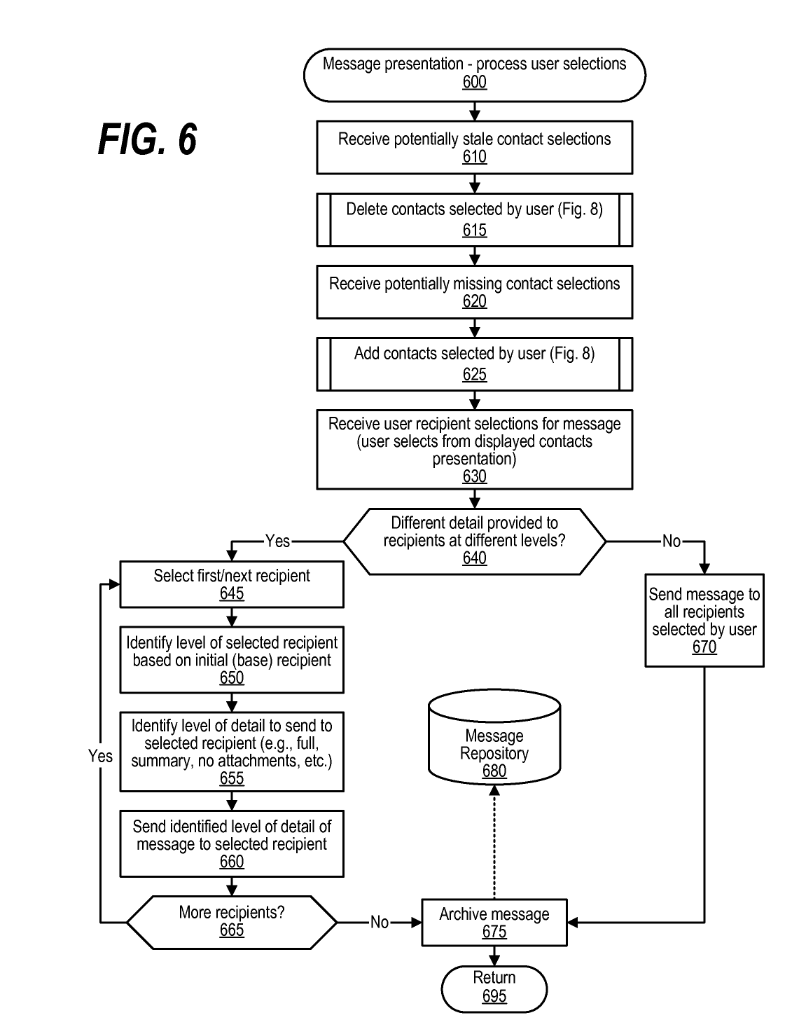

FIG. 6 is a flowchart depicting steps taken used to process user selections from the structured instant message presentation. Processing commences at 600 whereupon, at step 610, the process receives the potentially stale contact selections that were previously identified by the calling routine (see steps 540 and 560 in FIG. 5). The selected stale contact selections are those contacts that the user wishes to exclude, or remove, from a particular group. For example, a stale contact might be removed from an organizational reporting structure or from a project team. At predefined process 615, the stale contacts selected by the user are deleted from the identified group (see FIG. 8 and corresponding text for processing details). In addition, if a stale contact is no longer a contact whatsoever (e.g., leaves the organization, etc.), then the stale contact can be deleted entirely from the list of the user's contacts as the contact information (e.g., user identifier, email address, etc.) is no longer valid.

At step 620, the process receives the potentially missing contact selections that were previously identified by the calling routine (see steps 540 and 560 in FIG. 5). The selected missing contact selections are those contacts that are not currently in the group but the user wishes to include. For example, a contact might be added to an organizational reporting structure or to a project team. At predefined process 625, the missing contacts selected by the user are added to the identified group, such as the organizational reporting structure, project team, or the like (see FIG. 8 and corresponding text for processing details). In addition, if a missing contact was not in the list of the user's contacts and was found in an external data store, then in predefined process 625, the missing contact information can be added to the user's list of available contacts along with attribute (metadata) describing the contact as well as relationships between the missing contact and other contacts.

At step 630, the user, having been presented a topographical or non-topographical display of identified instant messaging contacts, selects the particular contacts to whom the user wishes the instant message to be delivered. A decision is made as to whether different levels of detail are being provided to various selected contacts based on the levels of the contacts (d 640). For example, in an organization reporting structure more detailed information in the instant message may be provided to lower-level contacts in the reporting structure with contacts in higher-level positions receiving summary data. If different amounts of detail are being provided to the various selected contacts, then decision 640 branches to the “yes” branch for further processing. At step 645, the first selected instant message contact (recipient) is selected from the list of instant messaging contacts that was displayed and selected by the user. At step 650, a reporting level of the selected instant message contact is identified. At step 655, a data detail is identified that corresponds with the level that has been identified for the selected instant message contact. At step 660, the process sends generates an instant message detail message that includes the identified data detail of the message and this generated instant message detail message is sent to the selected instant message contact. A decision is made as to whether there are more instant message contacts that have been selected by the user to receive the instant message (decision 665). If more instant message contacts have been identified to receive the instant message, then decision 665 branches to the “yes” branch which loops back to select the next instant message contact that was selected by the user and generate an instant message detail message corresponding to the contact's reporting level. This looping continues until there are no more instant message contacts that have been selected by the user to receive the instant message, at which point decision 665 branches to the “no” branch. On the other hand, if different levels of detail are not being provided to instant message contacts based upon the contacts' reporting level, then decision 640 branches to the “no” branch whereupon, at step 670, the instant message is sent to all of the instant message contacts that were selected by the user.

After the instant message has been sent, at step 675, the instant message is archived in instant message repository data store 680. As will be seen in FIG. 9, this instant message repository data store is periodically mined in order to further identify groups of contacts based on attributes in the archived messages (e.g., subject descriptions, etc.). After the message has been archived, then processing returns to the calling routine (see FIG. 5) at 695.

FIG. 7 is a flowchart depicting steps taken to update rules used to process instant message contact data in order to provide instant messaging presentation forms useful to the user. Update rules processing commences at 700 whereupon, at step 705, the process receives a instant messaging presentation rule name (identifier) that is either being created or modified by user 310. At step 710, the presentation type (topography or non-topography) is received from user 310. In addition, if the presentation type is a topography type, then the topography view (e.g., a star view, a tree view, a chain view, and a loop view) is also received from the user at step 710. At step 715, if the presentation type is a topography view that includes a number of reporting levels then, at step 715, the reporting levels that are to be included in the group are received from the user (e.g., all levels, next levels (up/down), a numeric level of levels, etc.) are received from the user. If the group involves a number of levels and the user wishes to send different data detail to contacts based upon the contacts' level within the organization, then step 720 is performed to define the data detail provided to the various levels (e.g., full detail, summary detail, no attachments, etc.). At step 725, a timing restriction that the user may wish to place on the instant messaging presentation rule is received. For example, the user may wish to have a particular rule active on weekdays within work hours or may wish to have a particular rule active only on weekends and holidays. When the user requests an instant message, the current timestamp is retrieved of the date/day/time that the instant message was created and this timing information is compared with any timing restrictions that the user has defined for various rules in order to include and/or exclude various instant messaging presentation rules based on timing restrictions.

A decision is made as to whether to apply the instant messaging presentation rule to a select group (or groups) of contacts or to all contacts (decision 730). If the user has elected to apply the rule to a select group (or groups) of contacts, then decision 730 branches to the “yes” branch whereupon, at step 735, the user selects the contacts (e.g., group or groups, etc.) to which the rule applies. On the other hand, if the user elects to apply the rule to all contacts, then decision 730 branches to the “no” branch whereupon, at step 740, the instant messaging presentation rule is applied to call of the user's instant messaging contacts.

A decision is made as to whether the user wishes to diagnose potentially missing contacts when sending a message based on the rule (decision 750). If the user wishes to diagnose missing contacts when the rule has been identified, then decision 750 branches to the “yes” branch whereupon, at step 755, a flag is set for the rule indicating that potentially missing contacts are to be identified. On the other hand, if the user does not wish to diagnose missing contacts when the rule has been identified, then decision 750 branches to the “no” branch whereupon, at step 760, the flag is set indicating that potentially missing contacts are not to be identified when this rule has been identified.

A decision is made as to whether the user wishes to diagnose potentially stale contacts when sending a message based on the rule (decision 770). If the user wishes to diagnose stale contacts when the rule has been identified, then decision 770 branches to the “yes” branch whereupon, at step 775, a flag is set for the rule indicating that potentially stale contacts are to be identified. On the other hand, if the user does not wish to diagnose stale contacts when the rule has been identified, then decision 770 branches to the “no” branch whereupon, at step 780, the flag is set indicating that potentially stale contacts are not to be identified when this rule has been identified.

At step 790, the instant messaging presentation rules data store 350 is update to include the rule configured by the user. Processing then returns to the calling routine (see FIG. 4) at 795.

FIG. 8 is a flowchart showing steps taken to update instant message contact information and messaging metadata. Processing used to update instant message contact and attribute information (metadata) commences at 800 whereupon, at step 810, the process receives a contact selected from the user. A decision is made as to whether the user wishes to add, modify, or delete the selected contact (decision 815). If the user is requesting to add a particular contact, then decision 815 branches to the “add” branch whereupon, at step 820, the a new contact is created for addition to the user's contact data store (e.g., memory allocated to store contact data, etc.). If the user is requesting to modify an existing contact, then decision 815 branches to the “modify” branch whereupon, at step 825 the existing contact data is retrieved that corresponds to the contact that is being modified. Steps 830 through 870 are performed for either contact “add” or contact “modify” operations. At step 830, a dialog is displayed allowing the user to edit the contact attributes (e.g., name, instant messaging address, organizational/group attributes, etc.). At step 835, the first relationship for the contact is selected (e.g., a project, an organization, an external data store defining organizational, project, or other group parameters, etc.). At step 840, the user is allowed to add, modify, or delete the selected relationship (e.g., removing the contact from a project, adding the contact to a department, modifying the name of a group to which the contact belongs, etc.). At decision 845, the process determines whether the relationship added, modified, or deleted b the user is defined in an external repository (e.g., an organizational chart, a project member listing, etc.). If the relationship is defined in an external repository, then decision 845 branches to the “yes” branch whereupon, at step 850, the contact's attributes are linked (or unlinked in the case of a deletion) with the external repository. A decision is made as to whether there are more relationships for the contact that the user wishes to add, delete, or modify (decision 860). If there are more relationships, then decision 860 branches to the “yes” branch which loops back to select and process the next relationship as described above. This looping continues until there are no more relationships that the user wishes to add, delete, or modify, at which point decision 860 branches to the “no” branch. At step 870, the additions, modifications, and deletions are stored to (or deleted from in the case of a deleted relationship) the appropriate instant messaging data stores including instant messaging contacts data store 320, instant messaging contact attributes data store 330, external repositories 360, and instant messaging contact relationships 340. Processing then returns to the calling routine (see FIG. 4 or FIG. 6) at 875.

Returning to decision 815, if the user is requesting to delete a particular contact, then decision 815 branches to the “delete” branch for further processing. At step 880, the identified contact's data is deleted from the various instant messaging data stores including instant messaging contacts data store 320, instant messaging contact attributes data store 330, external repositories 360, and instant messaging contact relationships 340. Processing then returns to the calling routine (see FIG. 4 or FIG. 6) at 895.

FIG. 9 is a flowchart showing steps taken to perform data mining on messages stored in a message repository to add instant message contact groups and update contact relationships. Data mining processing commences at 900 whereupon, at step 910, the process sorts the user's message repository (data store 680) by recipient and sender (the contact to whom the instant message was sent (recipient) or the contact from whom the instant message was received (sender)).

At step 915, the process selects the first contact from the sorted message repository data store 680. At step 920, the process selects the first message subject that the user had with the selected contact. At step 925, the number of messages with the selected contact having the same or similar subject are identified. A decision is made as to whether the number of messages with the selected contact that have the same or a similar subject exceed a user definable threshold (decision 930). If the number of messages with the selected contact that have the same or a similar subject exceeds the threshold, then decision 930 branches to the “yes” branch further processing.

At step 940, the process displays a dialog to the user suggesting that the user add a category for instant messaging regarding the identified subject and receives the user's response. In one embodiment, the process first identifies whether the category already exists and inhibits display of the dialog if the category has already been created.

A decision is made as to whether the user wishes to add a new instant messaging category (group) corresponding to the identified subject (decision 950). If the user wishes to add a new category (group) corresponding to the identified subject, then decision 950 branches to the “yes” branch whereupon, at step 955, the process identifies other contacts that have sent or received messages regarding the identified subject. At step 960, the process displays a dialog to the user listing the contacts that have sent or received instant messages regarding the identified subject and the user is invited to select various users (or groups, such as departments, etc.) to the group that is being created. The user interacts with the displayed dialog to select the contacts that the user wishes to add to the instant messaging group that is being added. The contacts that the user selects to add to the instant messaging group that is being added have their instant messaging contact relationships modified in relationships data store 340 to reflect the inclusion in the newly added group.

Returning to decision 930, if the number of messages with the selected contact that have the same or a similar subject does not exceed the threshold, then decision 930 branches to the “no” branch bypassing steps 940 through 960. In addition, returning to decision 950, if the user elects to not add a new category regarding the identified subject, then decision 950 branches to the “no” branch bypassing steps 955 and 960.

After the identified subject with the selected contact has been processed, a decision is made as to whether there are more instant messages with the selected contact (decision 970). If there are more instant messages with the selected contact, then decision 970 branches to the “yes” branch which loops back to select and process the next message subject with the selected instant messaging contact as described above. This looping continues until all message subjects with the selected contact have been processed, at which point decision 970 branches to the “no” branch. A decision is made as to whether there are more contacts in the sorted instant message repository to process (decision 980). If there are more contacts to process, then decision 980 branches to the “yes” branch to select and process the next contact as described above. This looping continues until there are no more contacts to process, at which point decision 980 branches to the “no” branch whereupon processing returns to the calling routine (see FIG. 4) at 995.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, any suitable combination of the foregoing, or a future developed computer readable storage medium. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). The connection may be physical or wireless.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method implemented by an information handling system comprising:
receiving an instant message request from a user, wherein the instant message request includes one or more requested attributes;
retrieving a plurality of instant messaging contacts from one or more instant messaging repositories, wherein the retrieved plurality of instant messaging contacts are based on the one or more requested attributes;
retrieving one or more instant messaging presentation rules that are configurable by the user;
selecting a presentation type based on the retrieved instant messaging presentation rules;
displaying the plurality of instant messaging contacts in a display format corresponding to the selected presentation type;
receiving one or more user selections corresponding to one or more of the plurality of instant messaging contacts being displayed; and
sending an instant message from the user to the selected instant message contacts.

2. The method of claim 1 further comprising:
retrieving the plurality of instant messaging contacts based on a previous inclusion of each of the plurality of instant messaging contacts in an instant messaging group, wherein the plurality of instant messaging contacts in the instant messaging group have one or more shared

3. The method of claim 2 further comprising:
identifying an additional contact in one of the instant messaging repositories not belonging to the instant messaging group, wherein the additional contact is identified based on the additional contact having at least one of the one or more shared attributes;
alerting the user of the identified additional contact, wherein the alert recommends that the additional contact be included in the instant messaging group; and
including the additional contact in the instant messaging group in response to the user concurring with the alert recommendation.

4. The method of claim 2 further comprising:
identifying a stale contact from the plurality of instant messaging contacts based on one or more attributes corresponding to the stale contact;
alerting the user of the identified stale contact, wherein the alert recommends that the additional contact be removed from the instant messaging group; and
removing the additional contact from the instant messaging group in response to the user concurring with the alert recommendation.

5. The method of claim 2 further comprising:
prior to the receiving of the instant message request from the user:
identifying the plurality of instant messaging contacts from a query of an instant message repository of previous instant messages, wherein the identification is based on a common subject communicated with each of the plurality of instant messaging adding the identified plurality of instant messaging contacts to the group based on the identification of the contacts from the query.

6. The method of claim 1 wherein the presentation type is a topography presentation, and wherein the topography presentation is selected from the group consisting of a star view, a tree view, a chain view, and a loop view.

7. The method of claim 1 further comprising:
identifying, based on the retrieved instant messaging presentation rules, a number of reporting levels from an organization chart included in one of the instant messaging repositories;
identifying a data detail corresponding to each of the identified reporting levels;
generating a plurality of instant message detail messages, wherein each of the instant message detail messages corresponds to one of the identified data details; and
sending one of the instant message detail messages to each of the selected instant message contacts based on the reporting level of the corresponding selected instant message contact.

8. The method of claim 1 further comprising:
retrieving a current timestamp corresponding to the received instant message request, wherein at least one of the retrieved instant messaging presentation rules was retrieved based on a timing restriction that matches

9. An information handling system comprising:
one or more processors;
a memory coupled to at least one of the processors;
a network interface that receives connects the information handling system to a communications network; and
a set of instructions stored in the memory and executed by at least one of the processors, wherein the set of instructions perform actions of:
receiving an instant message request from a user, wherein the instant message request includes one or more requested attributes;
retrieving a plurality of instant messaging contacts from one or more instant messaging repositories, wherein the retrieved plurality of instant messaging contacts are based on the one or more requested attributes;
retrieving one or more instant messaging presentation rules that are configurable by the user;
selecting a presentation type based on the retrieved instant messaging presentation rules;
displaying the plurality of instant messaging contacts in a display format corresponding to the selected presentation type;
receiving one or more user selections corresponding to one or more of the plurality of instant messaging contacts being displayed; and
sending an instant message from the user to the selected instant message contacts.

10. The information handling system of claim 9 wherein the actions further comprise:
retrieving the plurality of instant messaging contacts based on a previous inclusion of each of the plurality of instant messaging contacts in an instant messaging group, wherein the plurality of instant messaging contacts in the instant messaging group have one or more shared attributes.

11. The information handling system of claim 10 wherein the actions further comprise:
identifying an additional contact in one of the instant messaging repositories not belonging to the instant messaging group, wherein the additional contact is identified based on the additional contact having at least one of the one or more shared attributes;
alerting the user of the identified additional contact, wherein the alert recommends that the additional contact be included in the instant messaging group; and
including the additional contact in the instant messaging group in response to the user concurring with the alert recommendation.

12. The information handling system of claim 10 wherein the actions further comprise:
identifying a stale contact from the plurality of instant messaging contacts based on one or more attributes corresponding to the stale contact;
alerting the user of the identified stale contact, wherein the alert recommends that the additional contact be removed from the instant removing the additional contact from the instant messaging group in response to the user concurring with the alert recommendation.

13. The information handling system of claim 10 wherein the actions further comprise:
prior to the receiving of the instant message request from the user:
identifying the plurality of instant messaging contacts from a query of an instant message repository of previous instant messages, wherein the identification is based on a common subject communicated with each of the plurality of instant messaging contacts in prior instant messages; and
adding the identified plurality of instant messaging contacts to the group based on the identification of the contacts from the query.

14. The information handling system of claim 9 wherein the presentation type is a topography presentation, and wherein the topography presentation is selected from the group consisting of a star view, a tree view, a chain view, and a loop view.

15. The information handling system of claim 9 wherein the actions further comprise:
identifying, based on the retrieved instant messaging presentation rules, a number of reporting levels from an organization chart included in one of the instant messaging repositories;
identifying a data detail corresponding to each of the identified reporting levels;
generating a plurality of instant message detail messages, wherein each of the instant message detail messages corresponds to one of the identified data details; and
sending one of the instant message detail messages to each of the selected instant message contacts based on the reporting level of the corresponding selected instant message contact.

16. The information handling system of claim 9 wherein the actions further comprise:
retrieving a current timestamp corresponding to the received instant message request, wherein at least one of the retrieved instant messaging presentation rules was retrieved based on a timing restriction that matches the current timestamp.

17. A computer program product stored in a computer readable storage medium comprising instructions that, when executed by an information handling system, causes the information handling system to perform actions comprising:
receiving an instant message request from a user, wherein the instant message request includes one or more requested attributes;
retrieving a plurality of instant messaging contacts from one or more instant messaging repositories, wherein the retrieved plurality of instant messaging contacts are based on the one or more requested attributes;
retrieving one or more instant messaging presentation rules that are configurable by the user;
selecting a presentation type based on the retrieved instant messaging presentation rules;
displaying the plurality of instant messaging contacts in a display format corresponding to the selected presentation type;
receiving one or more user selections corresponding to one or more of the plurality of instant messaging contacts being displayed; and
sending an instant message from the user to the selected instant message contacts.

18. The computer program product of claim 17 wherein the actions further comprise:
retrieving the plurality of instant messaging contacts based on a previous inclusion of each of the plurality of instant messaging contacts in an instant messaging group, wherein the plurality of instant messaging contacts in the instant messaging group have one or more shared attributes.

19. The computer program product of claim 18 wherein the actions further comprise:
identifying an additional contact in one of the instant messaging repositories not belonging to the instant messaging group, wherein the additional contact is identified based on the additional contact having at least one of the one or more shared attributes;
alerting the user of the identified additional contact, wherein the alert recommends that the additional contact be included in the instant messaging group; and
including the additional contact in the instant messaging group in response to the user concurring with the alert recommendation.

20. The computer program product of claim 18 wherein the actions further comprise:
identifying a stale contact from the plurality of instant messaging contacts based on one or more attributes corresponding to the stale contact;
alerting the user of the identified stale contact, wherein the alert recommends that the additional contact be removed from the instant messaging group; and
removing the additional contact from the instant messaging group in response to the user concurring with the alert recommendation.

21. The computer program product of claim 18 wherein the actions further comprise:
prior to the receiving of the instant message request from the user:
identifying the plurality of instant messaging contacts from a query of an instant message repository of previous instant messages, wherein the identification is based on a common subject communicated with each of the plurality of instant messaging contacts in prior instant messages; and
adding the identified plurality of instant messaging contacts to the group based on the identification of the contacts from the query.

22. The computer program product of claim 17 wherein the presentation type is a topography presentation, and wherein the topography presentation is selected from the group consisting of a star view, a tree view, a chain view, and a loop view.

23. The computer program product of claim 17 wherein the actions further comprise:
identifying, based on the retrieved instant messaging presentation rules, a number of reporting levels from an organization chart included in one of the instant messaging repositories;
identifying a data detail corresponding to each of the identified reporting levels;
generating a plurality of instant message detail messages, wherein each of the instant message detail messages corresponds to one of the identified data details; and
sending one of the instant message detail messages to each of the selected instant message contacts based on the reporting level of the corresponding selected instant message contact.

24. The computer program product of claim 17 wherein the actions further comprise:
retrieving a current timestamp corresponding to the received instant message request, wherein at least one of the retrieved instant messaging presentation rules was retrieved based on a timing restriction that matches
